(19) United States
(12) Patent Application Publication
(10) Pub. No.: US 2025/0346795 A1
(43) Pub. Date: Nov. 13, 2025

(54) ACYLHYDRAZONE BOND-CONTAINING AMPHIPHOBIC POLYMER AND PREPARATION METHOD OF NANO AMPHIPHOBIC REVERSAL AGENT

(71) Applicant: CHINA UNIVERSITY OF PETROLEUM (EAST CHINA), Qingdao (CN)

(72) Inventors: Yanling WANG, Qingdao (CN); Wenjing SHI, Qingdao (CN); Di LI, Qingdao (CN); Ning XU, Qingdao (CN); Mengxin CHEN, Qingdao (CN); Shinan LIANG, Qingdao (CN); Chuanbao ZHANG, Qingdao (CN)

(73) Assignee: CHINA UNIVERSITY OF PETROLEUM (EAST CHINA), Qingdao (CN)

(21) Appl. No.: 18/293,960

(22) PCT Filed: May 10, 2023
(86) PCT No.: PCT/CN2023/093216

§ 371 Date: Jan. 31, 2024

(30) Foreign Application Priority Data
Feb. 2, 2023 (CN) 2023100519281

(51) Int. Cl. C09K 8/24

(52) U.S. Cl. CPC C09K 8/24

(57) ABSTRACT

The present disclosure relates to an acylhydrazone bond-containing amphiphobic polymerand a preparation of a nano amphiphobic reversal agent; the method includes: polymerizing 2-(perfluorohexyl)ethyl methacrylate, acrylamide, and diacetoneacrylamide monomers to a terpolymer, reacting with adipic acid dihydrazide to prepare an acylhydrazone bond-containing amphiphobic polymer, and reacting the polymer with vinyltrimethoxysilanized nanoparticles to prepare a nano amphiphobic reversal agent containing a polymer with an acylhydrazone bond; the nano amphiphobic reversal agent containing a polymer with an acylhydrazone bond of the present disclosure can change the core surface from hydrophilic and oleophilic to oleophobic and hydrophobic, and meanwhile has the advantages of salt tolerance, shear resistance, and the like, which is conductive to an increase in the recovery rate of crude oil.

### FIELD OF THE INVENTION

The present disclosure relates to an acylhydrazone bond-containing amphiphobic polymer and a preparation method of a nano amphiphobic reversal agent, and belongs to the technical field of wetting reversal agents for improved extraction efficiency in oil and gas fields.

### BACKGROUND OF THE INVENTION

During the development of condensate reservoirs, once the bottom hole pressure is falls below the dew point, the gas will condense to a liquid phase and accumulate near the wellbore region, resulting in a sharp decline in gas well productivity. In order to solve this problem, scholars have proposed removing condensate water near the wellbore by injecting carbon dioxide or propane. Nevertheless, field tests have proved that this method can only temporarily alleviate the problem of condensation water accumulation, but cannot solve it fundamentally. Wettability is an important parameter for determining fluid flow and distribution in condensate reservoirs. If the wettability of the near wellbore region can be changed from liquid wetting to gas wetting, the fluid flow ability will be significantly improved, which will further increase the productivity of condensate reservoirs.

Current reports on wetting reversal agents are mainly divided into the hydrophobic type, the oleophobic type, and the hydrophobic and oleophobic type (the amphiphobic type). For example, CN110982009A provides a fluorine-containing polymer microemulsion wetting reversal agent, which is prepared by polymerizing a fluorine substituted acrylate monomer and an acrylic monomer. The fluorine-containing polymer microemulsion wetting reversal agent changes reservoirs from water wettability to hydrophobicity. CN111647392A discloses a carbon-based nano wetting reversal agent and application thereof. The wetting reversal agent includes modified nano graphene oxide, a surfactant, and a solvent, and is applied to drilling fluid to keep the formation rock surface in a hydrophilic state and to change the wettability of the rock surface from oil wetting to water wetting, which is conductive to subsequent water flooding to water injection well or an increase in the well recovery rate. CN106634894A discloses a dual-cation fluorocarbon surfactant, a preparation method thereof, and application thereof as an amphiphobic wetting reversal agent. The dual-cation fluorocarbon surfactant provided in this disclosure can endow the rock with hydrophobic and oleophobic properties, with a water wetting angle greater than 100° and a hexadecane wetting angle greater than 70°. The amphiphobic effect of the dual-cation fluorocarbon surfactant of this disclosure on the core is not good enough. Particularly, the hexadecane wetting angle is less than 75°. It is far from achieving a highly amphiphobic effect.

Additionally, the formation is situated in a high-salt environment, and salt has a great impact on the viscosity of a polymer solution. Firstly, salt, as a small-molecule electrolyte, will shield charges of ionic groups on a polymer chain, weaken the electrostatic repulsion, make the long polymer chain curl up to form intramolecular association, and reduce the hydrodynamic volume, which is manifested as a decrease in viscosity. Secondly, the addition of salt will increase the polarity of a solvent, the electrostatic force of ions destroys the original water structure to form a layer of water molecules, which promotes hydration. In order to solve the foregoing problems of the polymers in the formation and the problem of unsatisfactory effects of the existing amphiphobic wetting reversal agents, the present disclosure is hereby proposed.

### SUMMARY OF THE INVENTION

In view of the deficiencies in the prior art, the present disclosure provides a preparation method and application of an acylhydrazone bond-containing amphiphobic polymer. The acylhydrazone bond-containing amphiphobic polymer is hydrophobic and oleophobic, and can be used as an amphiphobic reversal agent or used for preparing an amphiphobic reversal agent.

The present disclosure further provides a nano amphiphobic reversal agent containing a polymer with an acylhydrazone bond, and a preparation method and application thereof. The nano amphiphobic reversal agent of the present disclosure can achieve a highly amphiphobic effect on the core surface, and meanwhile has salt tolerance and shear resistance, so that it is effective in reservoirs for a long term.

### Description of Terms

Reversal agent: it is synonymous with wetting reversal agent.
Amphiphobic reversal agent: it refers to a hydrophobic and oleophobic wetting reversal agent.
High amphiphobicity: it refers to that after processing, a water wetting angle and a hexadecane wetting angle of the core surface are respectively greater than 1250 and 120°.
Room temperature: it has a well-known meaning in the art and generally refers to 25±2° C.

Technical solutions of the present disclosure are as follows:

An acylhydrazone bond-containing amphiphobic polymer has a structure represented by formula I:

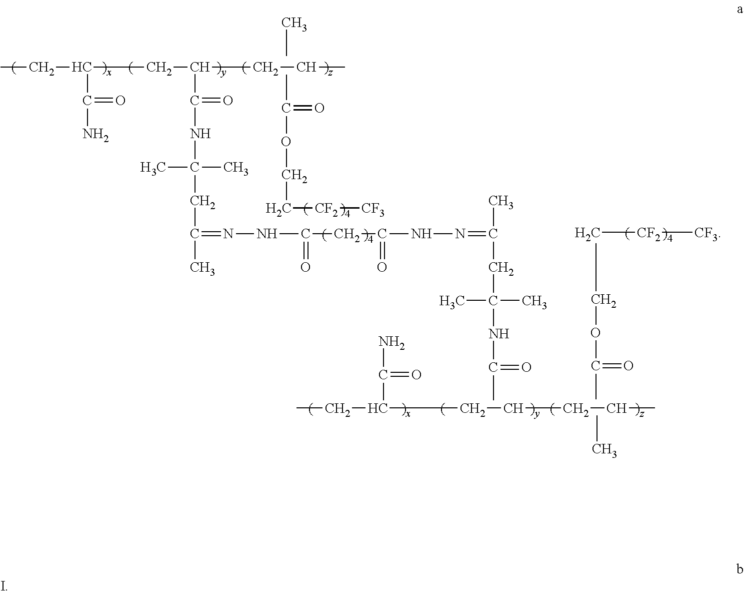

where, x, y, z=16-25.

According to the present disclosure, a preparation method of the acylhydrazone bond-containing amphiphobic polymer includes the following steps:
(1) dissolving acrylamide in deionized water, adding diacetone acrylamide to prepare an aqueous solution with a solid content of 12-17%. Then, adding 2-(perfluorohexyl)ethyl methacrylate, passing nitrogen to remove oxygen, adding ammonium persulfate, stirring uniformly, heating for polymerization under a nitrogen atmosphere to prepare a gelatinous product, and performing post-processing to prepare an intermediate product 1;
the molar ratio of acrylamide to diacetone acrylamide to 2-(perfluorohexyl)ethyl methacrylate being 100:(10-13):(1-7).

(2) respectively preparing an aqueous solution of the intermediate product 1 at a mass concentration of 1-10 wt. % and an aqueous solution of adipic acid dihydrazide at a mass concentration of 1-10 wt. %, mixing the two aqueous solutions uniformly to make a molar ratio of the intermediate product 1 to adipic acid dihydrazide 1:(1-3), regulating the pH with acetic acid to 2-5, and standing at room temperature for 18-24 h to prepare an acylhydrazone bond-containing amphiphobic polymer.

According to the preparation method of the acylhydrazone bond-containing amphiphobic polymer of the present disclosure, reaction conditions are preferably as follows:

At step (1), the molar ratio of acrylamide to diacetone acrylamide to 2-(perfluorohexyl)ethyl methacrylate is 100:(10-11):(1-5). The molar ratio of the three monomers is very important, especially the addition amount of 2-(perfluorohexyl)ethyl methacrylate, which has a critical influence on the yield of the synthetic product.

At step (1), the addition amount of ammonium persulfate accounts for 0.05-0.2% (mol) of the total amount of the monomers, and more preferably, the addition amount of ammonium persulfate accounts for 0.08-0.12% (mol) of the total amount of the monomers.

At step (1), the post-processing includes the following steps: immersing the gelatinous product in a large amount of acetone until the gelatinous product becomes hard, drying in a vacuum oven, and grinding to prepare the intermediate product 1. Preferably, the drying temperature is 50-80° C., and the drying time is 24-48 h. More preferably, the drying temperature is 60° C., and the drying time is 30 h.

Further preferably, at step (1), the reaction includes one or more of the following conditions:
a. nitrogen passes to remove oxygen for 20-30 min;
b. the heating and polymerization reaction temperature is 60-80° C.; and
c. the heating time is 6-10 h.

More preferably, at step (1), the heating and polymerization reaction temperature is 70° C., and the heating time is 8 h.

According to the preparation method of the acylhydrazone bond-containing amphiphobic polymer, preferably, at step (2), the molar ratio of the intermediate product 1 to adipic acid dihydrazide is 1:(1-2), and most preferably, the molar ratio of the intermediate product 1 to adipic acid dihydrazide is 1:1.

According to the preparation method of the acylhydrazone bond-containing amphiphobic polymer, preferably, at step (2), an aqueous solution of the intermediate product 1 at a concentration of 4-6 wt. % and an aqueous solution of adipic acid dihydrazide at a mass concentration of 4-6 wt. % are prepared. Most preferably, both the concentration of the aqueous solution of the intermediate product 1 and the mass concentration of the aqueous solution of adipic acid dihydrazide are 5 wt. %.

According to the preparation method of the acylhydrazone bond-containing amphiphobic polymer, preferably, at step (2), the pH is regulated to 3-4, more preferably, the pH is regulated to 3.2; the concentration of acetic acid is 30-40 wt. %, and most preferably, the concentration of acetic acid is 36 wt. %; and the solution is placed in room temperature for 20-28 h.

According to the present disclosure, preferably, the weight-average molecular weight of the acylhydrazone bond-containing amphiphobic polymer is 11000-17000, and more preferably, the weight-average molecular weight is 15000-16000.

A preparation reaction route of the acylhydrazone bond-containing amphiphobic polymer of the present disclosure is as follows:

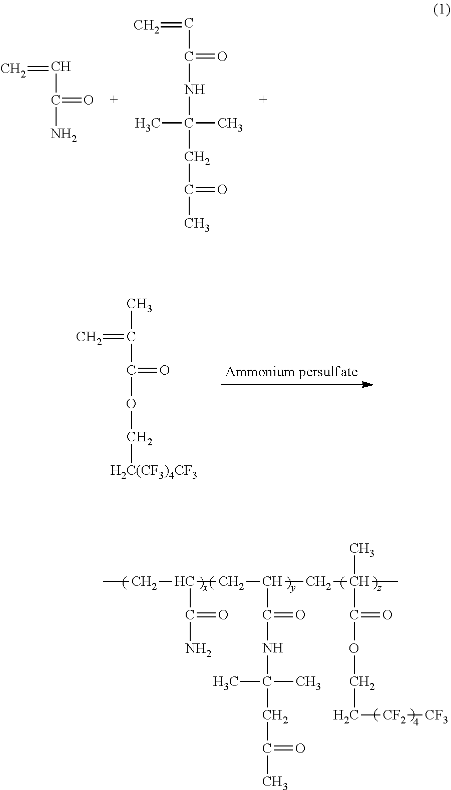

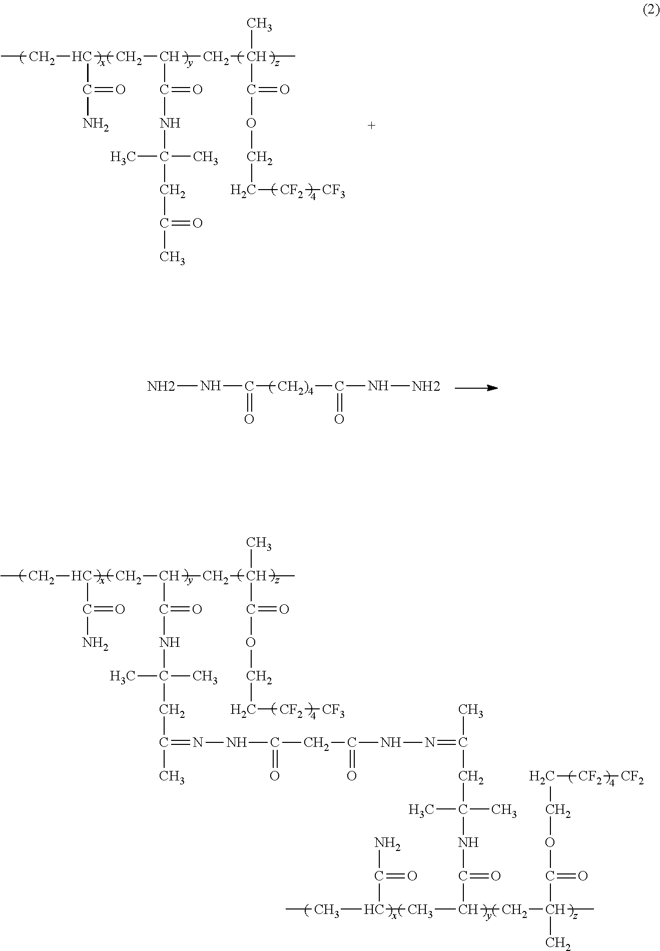

where, x, y, z=16-25.

The acylhydrazone bond-containing amphiphobic polymer that is prepared in the present disclosure is hydrophobic and oleophobic, and is used as an amphiphobic reversal agent or used for preparing an amphiphobic reversal agent.

A nano amphiphobic reversal agent containing a polymer with an acylhydrazone bond is prepared by reacting the acylhydrazone bond-containing amphiphobic polymer of the present disclosure with vinyltrimethoxysilanized nanoparticles.

The nanoparticles are selected from nano silica, nano titanium dioxide, nano graphene oxide or the like. Preferably, the nanoparticles are nano silica, and further preferably, the nanoparticles are hydrophilic nano silica.

More detailed, a preparation method of a nano amphiphobic reversal agent containing a polymer with an acylhydrazone bond includes the following steps:
reacting a vinyltrimethoxysilane coupling agent with nano silica in an alcohol solvent to prepare vinyltrimethoxysilanized nano silica particles;
mixing the acylhydrazone bond-containing amphiphobic polymer with the vinyltrimethoxysilanized nano silica particles, adding an initiator, and performing heating reaction to prepare a nano amphiphobic reversal agent containing a polymer with an acylhydrazone bond.

Preferably, at step (I), the alcohol solvent is absolute ethanol. The reaction temperature is 50-70° C.

Preferably, at step (I), a mass ratio of the vinyltrimethoxysilane coupling agent to nano silica is 1:(1-3).

Preferably, at step (II), a mass ratio of the acylhydrazone bond-containing amphiphobic polymer to the vinyltrimethoxysilanized nano silica particles is (3-5):1, and more preferably, the mass ratio is 4:1.

Preferably, at step (II), the initiator is one or more of azodiisobutyronitrile, benzoyl peroxide, and dicyclohexylperoxydicarbonate, and more preferably, the initiator is azodiisobutyronitrile.

Preferably, at step (II), the reaction temperature is 60-80° C., and the reaction time is 4-5 h, and more preferably, the reaction temperature is 70° C., and the reaction time is 4 h. The product can be applied directly without post-processing.

A preparation reaction route of the nano amphiphobic reversal agent containing a polymer with an acylhydrazone bond of the present disclosure is as follows:

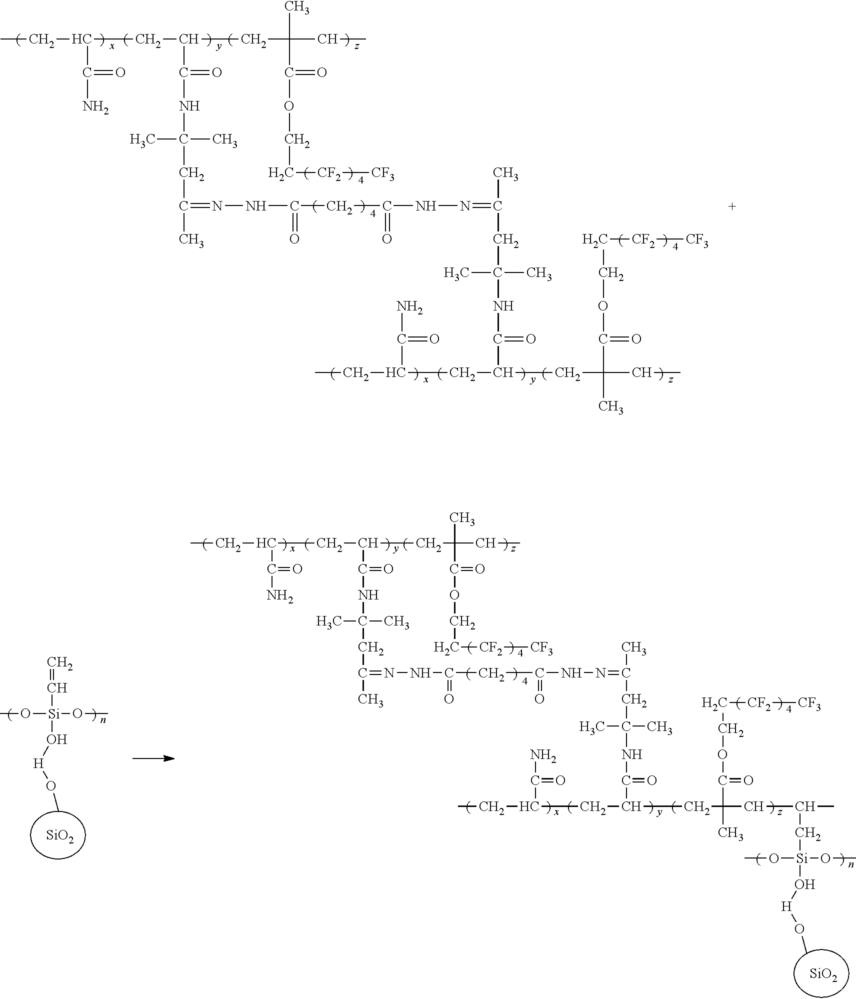

where, x, y, z=16-25, and n=1000-5000.

The present disclosure provides application of the nano amphiphobic reversal agent containing a polymer with an acylhydrazone bond. The nano amphiphobic reversal agent is used for the development of condensate reservoirs to form a wetting adsorption layer on the formation core surface, so that the core surface is changed from hydrophilic and oleophilic to hydrophobic and oleophobic.

Preferably, the working concentration of nano amphiphobic reversal agent containing a polymer with an acylhydrazone bond in a working fluid is 0.05-2 wt. %, and more preferably, the working concentration is 1 wt. %.

Technical features and beneficial effects of the present disclosure:
The preparation method of the acylhydrazone bond-containing amphiphobic polymer of the present disclosure includes two steps. At step (1), three monomers (that is, acrylamide, diacetone acrylamide, and 2-(perfluorohexyl)ethyl methacrylate) are polymerized under specific conditions, and at step (2), the polymerization product reacts with adipic acid dihydrazidein the presence of acid, and the chain molecules are linked to form a net structure so as to prepare an acylhydrazone bond-containing amphiphobic polymer. The product can be applied on site without purification. The polymer is hydrophobic and oleophobic, and is used for reversing the wettability of the core surface. The polymer contains abundant fluorine-containing functional groups, which greatly reduce the surface energy. The interaction between the ketone carbonyl group and the hydrazide group in the polymer can improve the stability and salt tolerance of the wetting reversal agent system. It successfully overcomes the influence of salt in the high-salt environment of the formation on the properties of the polymer of the prior art.
The nano amphiphobic reversal agent containing a polymer with an acylhydrazone bond of the present disclosure forms a dynamic network structure on the basis of a hydrophobic association physical network to improve the stability and salt tolerance of the wetting reversal agent system. In addition, the dynamically reversible properties of the acylhydrazone bond enables the molecular weight and viscosity of the acylhydrazone bond-containing amphiphobic polymer to be recovered even after it has been sheared forcefully, so that an irreversible decrease in the molecular weight of a conventional polymer solution after it has been sheared by porous media in the formation is overcome, and good wetting reversal properties are maintained. Because there is no charge on the molecular chain of the nano amphiphobic reversal agent containing a polymer with an acylhydrazone bond of the present disclosure, the charge shielding effect is avoided.
The nano amphiphobic reversal agent containing a polymer with an acylhydrazone bond of the present disclosure is absorbed on the core surface in the formation through the electrostatic force and hydrogen bonds to form a wetting adsorption layer. The fluorocarbon chain reduces the surface free energy, and the nanoparticles increase the surface roughness, so that the core surface can be changed from hydrophilic and oleophilic to hydrophobic and oleophobic, or highly amphiphobic, or even superamphiphobic (hydrophobic and oleophobic). A water contact angle and a hexadecane contact angle can respectively reach 1470 and 135°.

### DETAILED DESCRIPTION OF THE EMBODIMENTS

The present disclosure will be further described below with reference to embodiments, but the present disclosure is not limited to the embodiments. All raw materials used in the embodiments are commercially available. Unless otherwise specified, “%” in the embodiments is mass percentage, and the yield is the total yield (mass).

Preparation of vinyltrimethoxysilanized nano silica particles: a vinyltrimethoxysilane coupling agent was mixed with nano silica in a mass ratio of 1:1, and the mixture reacted in absolute ethanol at 50° C. for 4 h to prepare vinyltrimethoxysilanized nano silica particles. This product can be used as a raw material in the following embodiments without post-processing.

### Example 1 Preparation of Acylhydrazone Bond-Containing Amphiphobic Polymer

0.05 mol of acrylamide was dissolved in deionized water, 0.0055 mol of diacetone acrylamide was added to prepare an aqueous solution with a solid content of 15%, and 0.0005 mol of 2-(perfluorohexyl)ethyl methacrylate was added. Nitrogen passed to remove oxygen for 30 min, ammonium persulfate whose addition amount accounted for 0.01% (mol) of the total amount of the monomers was added, and the mixture was stirred uniformly. The mixture was heated to 70° C. for polymerization for 8 h under a nitrogen atmosphere to prepare a uniform and transparent gelatinous product, and the product was immersed in a large amount of acetone until the product became hard, dried in a vacuum drying oven, and ground to prepare an intermediate product 1. An aqueous solution of the intermediate product 1 at a concentration of 5% and an aqueous solution of adipic acid dihydrazide at a concentration of 5% were respectively prepared, the two aqueous solutions were mixed uniformly according to a molar ratio of the intermediate product 1 to adipic acid dihydrazide of 1:1, the pH was regulated with acetic acid at a concentration of 36% to 3.2, and the solution was stood at room temperature for 24 h to prepare an acylhydrazone bond-containing amphiphobic polymer. The yield was 87.2%.

### Example 2 Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.001 mol. The yield was 89.3%.

### Example 3 Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.0015 mol. The yield was 90.1%.

### Example 4 Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.002 mol. The yield was 90.6%.

### Example 5 Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.0025 mol. The yield was 91.1%.

### Example 6 Preparation of Acylhydrazone Bond-Containing Amphiphobic Polymer

Preparation conditions were the same as those described in Example 1, and differences from Example 1 were that the addition amount of diacetone acrylamide was changed from 0.0055 mol to 0.005 mol, and the addition amount of 2-(perfluorohexyl)ethyl methacrylate was 0.0025 mol. The yield was 90.9%.

### Example 7 Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.0035 mol. The yield was 90.7%.

### Comparative Example (Synthetic): Preparation of Acylhydrazone Bond-Containing Amphiphobic Polymer

Preparation conditions were the same as those described in Example 1, and a difference from Example 1 was that the addition amount of 2-(perfluorohexyl)ethyl methacrylate was 0.004 mol. The yield was 90.5%.

It can be known from comparison of Examples 1 to 7 and Comparative Example (synthetic) that the addition amount of 2-(perfluorohexyl)ethyl methacrylate is positively related to the yield of the synthetic product. However, the addition amount of 2-(perfluorohexyl)ethyl methacrylate does not contribute much to the increase of productivity when reaching a certain level.

### Example 8 Preparation of Nano Amphiphobic Reversal Agent Containing a Polymer with an Acylhydrazone Bond

After the acylhydrazone bond-containing amphiphobic polymer that was prepared in Example 5 was mixed with the vinyltrimethoxysilanized nano silica particles in a mass ratio of 3:1, 0.01 mol of azodiisobutyronitrile was added, and the mixture was heated to 70° C. and reacted for 4 h to finally prepare a dynamic acylhydrazone bond-containing nano amphiphobic reversal agent.

### Example 9 Preparation of Nano Amphiphobic Reversal Agent Containing a Polymer with an Acylhydrazone Bond

Preparation conditions were the same as those described in Example 8, and a difference from Example 8 was that the acylhydrazone bond-containing amphiphobic polymer was mixed with the vinyltrimethoxysilanized nano silica particles in a mass ratio of 4:1.

### Example 10 Preparation of Nano Amphiphobic Reversal Agent Containing a Polymer with an Acylhydrazone Bond

Preparation conditions were the same as those described in Example 8, and a difference from Example 8 was that the acylhydrazone bond-containing amphiphobic polymer was mixed with the vinyltrimethoxysilanized nano silica particles in a mass ratio of 5:1.

Property tests of the related products are described below.

### Test I: Hydrophobicity and Oleophobicity

### Comparative Example 1: Deionized Water

Cores were immersed: pre-processed cores were respectively immersed in deionized water of Comparative Example 1 and solutions respectively containing the product samples of Examples 1 to 10 at a concentration of 1 wt. % at room temperature for 24 h, taken out, and oven-dried in an electric constant temperature drying oven at 80° C., and their surfaces were wiped. Contact angles were measured. An oil phase test fluid was hexadecane, and a water phase test fluid was distilled water. Results are shown in Table 1.

TABLE 1

| Sample | Water contact angle | Hexadecane contact angle |
|---|---|---|
| Example 1 | 135° | 128° |
| Example 2 | 128° | 127° |
| Example 3 | 133° | 125° |
| Example 4 | 130° | 124° |
| Example 5 | 132° | 122° |
| Example 6 | 130° | 119° |
| Example 7 | 131° | 117° |
| Comparative | 127° | 115° |
| Example | | |
| (synthetic) | | |
| Example 8 | 144° | 126° |
| Example 9 | 147° | 135° |
| Example 10 | 145° | 131° |
| Comparative | 19° | 0° |
| Example 1 | | |

In can be known that the acylhydrazone bond-containing amphiphobic polymer and the nano amphiphobic reversal agent containing a polymer with an acylhydrazone bond can reverse the wettability of the reservoir core to highly amphiphobic (oleophobic and hydrophobic), and a water contact angle and a hexadecane contact angle of the core surface can respectively reach 1470 and 135° (super-amphiphobic).

### Test II: Salt Tolerance

Inorganic salts, that is, 10000 mg/L of sodium chloride and 300 mg/L of calcium chloride, were added to aqueous solutions containing the product samples of Examples 1 to 10 at a concentration of 1 wt. %, the mixture was stirred until the inorganic salts were dissolved, and the viscosity and interfacial tension of the solution were measured. Before and after the solution was sheared by using a shear apparatus at 2000 rpm for 30 s, the viscosity of the solution was measured by using a Brookfield viscometer at 45° C. Results are shown in Table 2.

TABLE 2

| | Viscosity | Viscosity | | |
|---|---|---|---|---|
| | before | after | Viscosity | Interfacial |
| | shearing | shearing | retention | tension |
| Example | (mPa · s) | (mPa · s) | rate (%) | (mN/m) |
| Example 1 | 25.1 | 15.3 | 67 | 0.0201 |
| Example 2 | 23.5 | 15.51 | 66 | 0.0183 |
| Example 3 | 30.2 | 20.23 | 67 | 0.0210 |
| Example 4 | 25.1 | 16.57 | 66 | 0.0199 |
| Example 5 | 26.1 | 18.0 | 69 | 0.0230 |
| Example 6 | 25.7 | 17.8 | 68 | 0.0220 |
| Example 7 | 26.1 | 18.1 | 68 | 0.0210 |
| Example 8 | 27.6 | 20.1 | 73 | 0.0167 |
| Example 9 | 28.3 | 21.51 | 76 | 0.0150 |
| Example 10 | 27.6 | 19.87 | 72 | 0.0210 |

It can be known from Table 2 that the viscosity of the acylhydrazone bond-containing amphiphobic polymer or the nano amphiphobic reversal agent containing a polymer with an acylhydrazone bond is high under the condition of salinity greater than 10000 mg/L, with the viscosity retention rate greater than 60%. It indicates that the acylhydrazone bond-containing amphiphobic polymer and the nano amphiphobic reversal agent containing a polymer with an acylhydrazone bond of the present disclosure have good salt tolerance. Therefore, the negative influence of the high-salt environment of the formation on the properties of the polymer of the prior art is avoid.

1-10. (canceled)

11. An acylhydrazone bond-containing amphiphobic polymer, having the structure represented by formula I: 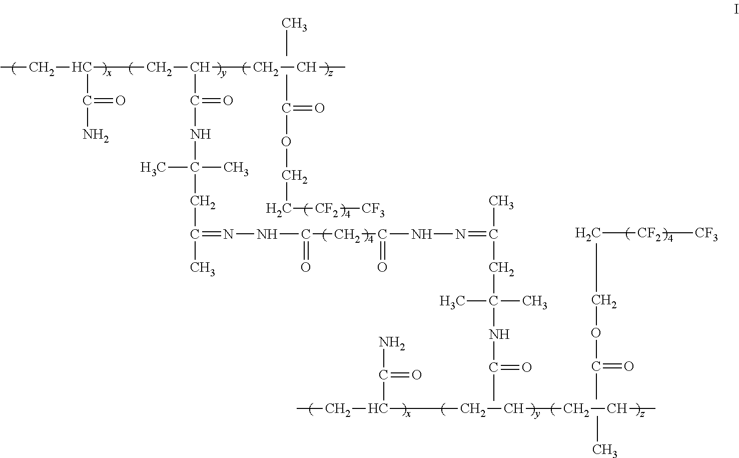
where, x, y, z=16-25.

12. The acylhydrazone bond-containing amphiphobic polymer according to claim 11, wherein the acylhydrazone bond-containing amphiphobic polymer is prepared by the following steps:
(i) dissolving acrylamide in deionized water, adding diacetone acrylamide to prepare an aqueous solution with a solid content of 12-17%, adding 2-(perfluorohexyl)ethyl methacrylate, passing nitrogen to remove oxygen, adding ammonium persulfate, stirring uniformly, performing a heating reaction under a nitrogen atmosphere, and performing post-processing to prepare an intermediate product 1,
a molar ratio of acrylamide to diacetone acrylamide to 2-(perfluorohexyl)ethyl methacrylate being 100:(10-13):(1-7); and
(ii) respectively preparing an aqueous solution of the intermediate product 1 at a mass concentration of 1-10 wt. % and an aqueous solution of adipic acid dihydrazide at a mass concentration of 1-10 wt. %, mixing the two aqueous solutions uniformly to make a molar ratio of the intermediate product 1 to adipic acid dihydrazide 1:(1-3), regulating the pH with acetic acid to 2-5, and standing at room temperature for 18-24 h to prepare an acylhydrazone bond-containing amphiphobic polymer.

13. The acylhydrazone bond-containing amphiphobic polymer according to claim 12, wherein at step (i), the post-processing comprises the following steps: immersing the gelatinous product in a large amount of acetone until the gelatinous product become hard, drying in a vacuum drying oven, and grinding to prepare the intermediate product 1, the drying temperature is 50-80° C., and the drying time is 24-48 h.

14. The acylhydrazone bond-containing amphiphobic polymer according to claim 12, wherein at step (i), the reaction comprises one or more of the following conditions:
a. the molar ratio of acrylamide to diacetone acrylamide to 2-(perfluorohexyl)ethyl methacrylate is 100:(10-11):(1-5);
b. the addition amount of ammonium persulfate accounts for 0.05-0.2% (mol) of the total amount of the monomers;
c. nitrogen passes to remove oxygen for 20-30 min;
d. the heating reaction temperature is 60-80° C.; and
e. the heating time is 6-10 h.

15. The acylhydrazone bond-containing amphiphobic polymer according to claim 12, wherein at step (ii), the reaction comprises one or more of the following conditions:
a. the molar ratio of the intermediate product 1 to adipic acid dihydrazide is 1:(1-2);
b. the aqueous solution of the intermediate product 1 at a concentration of 4-6 wt. % and the aqueous solution of adipic acid dihydrazide at a mass concentration of 4-6 wt. % are prepared;
c. the pH is regulated to 3-4;
d. the concentration of acetic acid is 30-40 wt. %; and
e. the solution is stood at room temperature for 20-28 h.

16. The acylhydrazone bond-containing amphiphobic polymer according to claim 12, wherein the weight-average molecular weight of the acylhydrazone bond-containing amphiphobic polymer is 11000-17000.

17. A nano amphiphobic reversal agent containing a polymer with an acylhydrazone bond, prepared by reacting the acylhydrazone bond-containing amphiphobic polymer according to claim 1 with vinyltrimethoxysilanized nanoparticles, the nanoparticles being selected from nano silica, nano titanium dioxide or nano graphene oxide.

18. The nano amphiphobic reversal agent according to claim 17, comprising the following steps:
(I) reacting a vinyltrimethoxysilane coupling agent with nano silica in an alcohol solvent to prepare vinyltrimethoxysilanized nano silica particles; and
(II) mixing the acylhydrazone bond-containing amphiphobic polymer with the vinyltrimethoxysilanized nano silica particles prepared at step (I), adding an initiator, and performing a heating reaction to prepare a nano amphiphobic reversal agent containing a polymer with an acylhydrazone bond.

19. The nano amphiphobic reversal agent according to claim 18, wherein the reaction comprises one or more of the following conditions:
a. at step (I), the alcohol solvent is absolute ethanol;
b. at step (I), the reaction temperature is 50-70° C.;
c. at step (I), a mass ratio of the vinyltrimethoxysilane coupling agent to nano silica is 1:(1-3);
d. at step (II), a mass ratio of theacylhydrazone bond-containing polymer to the vinyltrimethoxysilanized nano silica particles is (3-5):1;
e. at step (II), the initiator is one or more ofazodiisobutyronitrile, benzoyl peroxide, and dicyclohexylperoxydicarbonate;
f. at step (II), the reaction temperature is 60-80° C.; and
g. at step (II), the reaction time is 4-5 h.

20. A method for utilizing the nano amphiphobic reversal agent of claim 17, wherein making the nano amphiphobic reversal agent in the formation core surface to form a wetting adsorption layer, wherein the core surface is changed from hydrophilic and oleophilic to hydrophobic and oleophobic.
